(19) United States
(12) Patent Application Publication
(10) Pub. No.: US 2009/0040065 A1
(43) Pub. Date: Feb. 12, 2009

(54) CLASS 1, DIVISION 1 LED WARNING LIGHT

(75) Inventors: John Dalton, New Lenox, IL (US); Tim Skertich, JR., Dyer, IN (US)

Correspondence Address: MERCHANT & GOULD PC, P.O. BOX 2903, MINNEAPOLIS, MN, 55402-0903, US

(73) Assignee: Federal Signal Corporation, Oak Brook, IL (US)

(21) Appl. No.: 11/837,137

(22) Filed: Aug. 10, 2007

(51) Int. Cl. G09F 9/33

(52) U.S. Cl. 340/815.45

(57) ABSTRACT

A warning light and a method of providing a warning light signal are disclosed. A warning light includes a control system configured to receive a power supply and generate a pulsating output. At least one light-emitting diode (LED) array is configured to receive the pulsating output and generate a pulsating light having a predetermined intensity and appearing to a human eye to include a steady-state light. A housing is configured to contain the warning light. The housing includes a base configured to contain the control system and receive the power supply, a light-conductive dome configured to receive the LED array, and a coupling configured to join the dome to the base. By powering the LED array to generate a pulsating light, and possibly including a heat-dissipating device to transfer heat from the LED array, the warning light operates at a reduced temperature.

### TECHNICAL FIELD

The present disclosure relates generally to lighting and safety systems. In particular, the present disclosure relates to warning lights used in situations where there is a combustion risk.

### BACKGROUND

Warning lights are important for alerting people of impending dangers. For example, in facilities where combustible materials may be present, such as chemical plants, petroleum refineries, mines, and similar facilities, it is important to warn personnel of the risk of fires or explosions. Warning lights call attention to such dangers to ensure that personnel take appropriate precautions.

In general, warning lights should generate bright light, provide reliable operation, and, because many warning lights are powered by exhaustible batteries, operate efficiently. For their brightness and reliability, the light sources used in warning lights often include incandescent light bulbs, metal halide lamps, and high-pressure sodium lamps. These light sources provide bright light and are generally considered reliable, even if they are not particularly energy efficient.

In situations where there may be combustible materials present, however, these light sources may not present suitable choices because of the substantial amount of heat they generate. Where combustible materials may be present, safety standards limit a maximum temperature a device can generate relative to an ambient temperature to avoid the risk that heat generated by the device may ignite combustible materials. There are different limits for different types of applications. For example, a device to be used in an environment where there may be combustible solids present can safely operate at a higher temperature than can a device to be deployed where combustible gases may be present.

Temperature codes or “T-codes” are used to specify, relative to a given ambient temperature, a maximum increase in operating temperature the surface of the device will generate. For example, for a device to be assigned a best T-code of T6, which allows the device to be deployed even in locations where combustible gas may be present, the surface of the device must not result in a surface temperature increase of more than 10 degrees over an ambient temperature range up to 66 degrees Celsius.

Because of the heat generated by incandescent bulbs, metal halide lamps, and high-pressure sodium lamps, warning lights using these light sources necessarily employ large housings. The large housings provide a large volume over across which heat generated by the light source can be dissipated, thereby allowing a warning light using a hot light source to operate within specified temperature ranges. Unfortunately, large housings are bulky, heavy, and may be cumbersome to deploy.

For these and other reasons, improvements are desired.

### SUMMARY

The above and other problems are addressed by the following:

In one aspect, a warning light is disclosed. The warning light includes a control system configured to receive a power supply and generate a pulsating output. At least one light-emitting diode (LED) array is configured to receive the pulsating output and generate a pulsating light having a predetermined intensity and appearing to a human eye to include a steady-state light. A housing is configured to contain the warning light. The housing includes a base configured to contain the control system and receive the power supply, a light-conductive dome configured to receive the LED array, and a coupling configured to join the dome to the base. By powering the LED array to generate a pulsating light, and possibly including a heat-dissipating device to transfer heat from the LED array, the warning light operates at a reduced temperature.

In a second aspect, a warning light also is disclosed. The warning light includes a control system configured to receive a power supply and generate a pulse-width modulated output. At least one heat-dissipating light-emitting diode (LED) array is configured to receive the pulse-width modulated output and generate a pulsating light appearing to a human eye to include a steady-state light of at least a predetermined intensity. The heat-dissipating LED array includes a plurality of LEDs configured to generate light in a selected spectrum and a heat-dissipating device configured to be disposed one of against or adjacent to the plurality of LEDs and dissipate heat generated by the LEDs. A housing is provided to contain the warning light. The housing includes a base configured to contain the control system and receive the power supply. The housing also includes a lens configured to be disposed about the LED array and pass light in a spectrum equal to the selected spectrum in which the LEDs generate light and a light-conductive dome configured to contain the lens and the LED array. The housing also includes a coupling configured to join the dome to the base. The warning light radiates a temperature within a specified temperature range.

In a third aspect, a method of generating a warning light signal is disclosed. In generating the warning light signal, at least one light-emitting diode (LED) array is provided and configured to generate light in a selected spectrum. The LED array is received in a lens that is color-matched to pass light in the selected spectrum. A pulsating power signal is provided to the LED array, causing the LED array to generate a pulsating light appearing to a human eye to include a steady-state light of at least a predetermined intensity. The LED array is contained within a housing. An operating temperature radiated by the housing is limited by configuring the pulsating power signal to limit heat generated by the LED array and dispersing heat generated by the LED array through the housing.

### BRIEF DESCRIPTION OF THE DRAWINGS

In the drawings, like numerals represent like elements. The first digit in three-digit reference numerals and the first two digits in four-digit reference numerals refer to the figure in which the referenced element first appears.

FIG. 1 is perspective view of a self-contained warning light according to one possible implementation of the present disclosure;

FIG. 2 is a perspective view of an externally-powered warning light according to one possible implementation of the present disclosure;

FIG. 3 is a cutaway view of a heat tube used to dissipate heat from light-emitting diodes used in possible implementations of the present disclosure;

FIG. 4 is a cross-sectional view of an LED coupled with a heat sink such as the heat tube of FIG. 3 to dissipate heat according to possible implementations of the present disclosure;

FIGS. 5A and 5B are top and side views, respectively, of heat-dissipating LED arrays according to possible implementations of the present disclosure;

FIG. 6 is a side elevation view of a plurality of heat-dissipating LED arrays used in possible implementations of the present disclosure;

FIG. 7 is a cross-sectional view of a warning light using a plurality of heat-dissipating LED arrays according to a possible implementation of the present disclosure;

FIG. 8 is a schematic diagram of an alternating current (AC) powered control system for a warning light for providing a pulsating power signal to the LED arrays according to a possible implementation of the present disclosure;

FIG. 9 is a schematic diagram of a direct current (DC) powered control system for a warning light for providing a pulsating power signal to the LED arrays according to a possible implementation of the present disclosure; and

FIG. 10 is a flow diagram for providing a temperature-limited warning light signal to according to a possible implementation of the present disclosure.

### DETAILED DESCRIPTION

The present disclosure relates to a warning light suitable to generate a light signal of a predetermined intensity while limiting the operating temperature of the warning light so that it can be deployed even in temperature-sensitive conditions, such as where combustible materials are present. Implementations of the present disclosure employ heat-dissipating LED arrays configured to transfer heat from the LEDs to a housing of the warning light to facilitate dispersal of the heat generated. Moreover, the LED arrays are powered with a pulsating signal, such as a pulse-width modulated signal, to generate light that appears to a human eye to be a steady-state light while, at the same time, reducing the heat generated by the LEDs. Implementations of the present disclosure result in a waning light that can operate with a T-Code of T6 and can satisfy Class 1, Division 1 standards for warning lights.

### Warning Lights According to Possible Implementations of the Present Disclosure

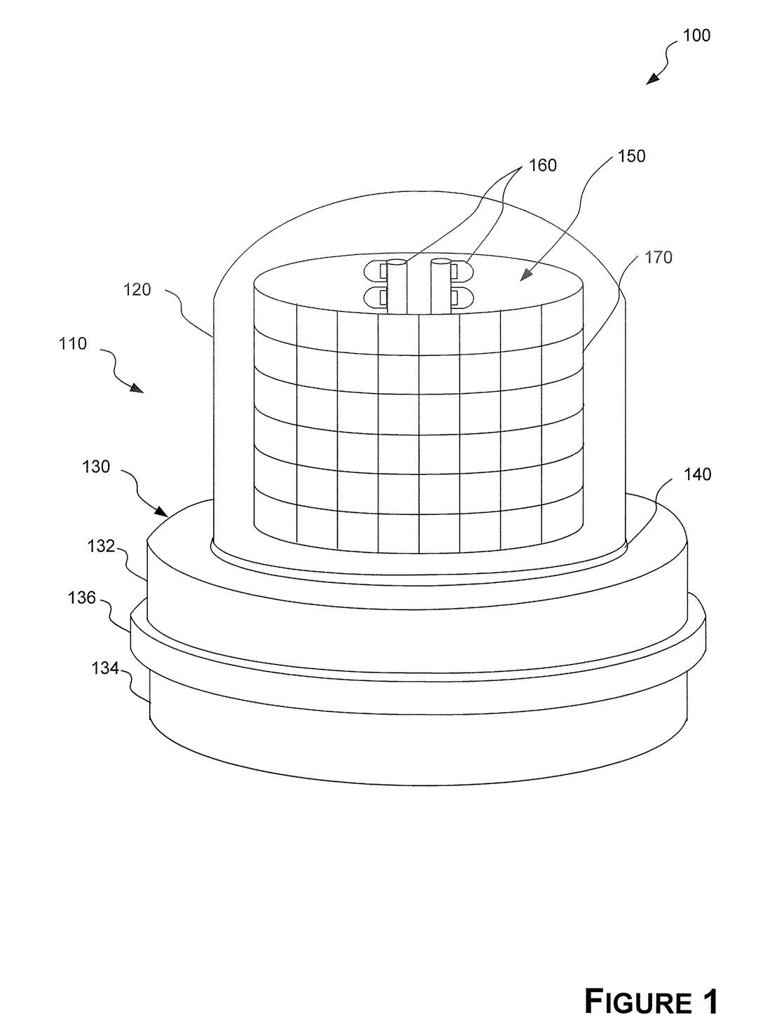

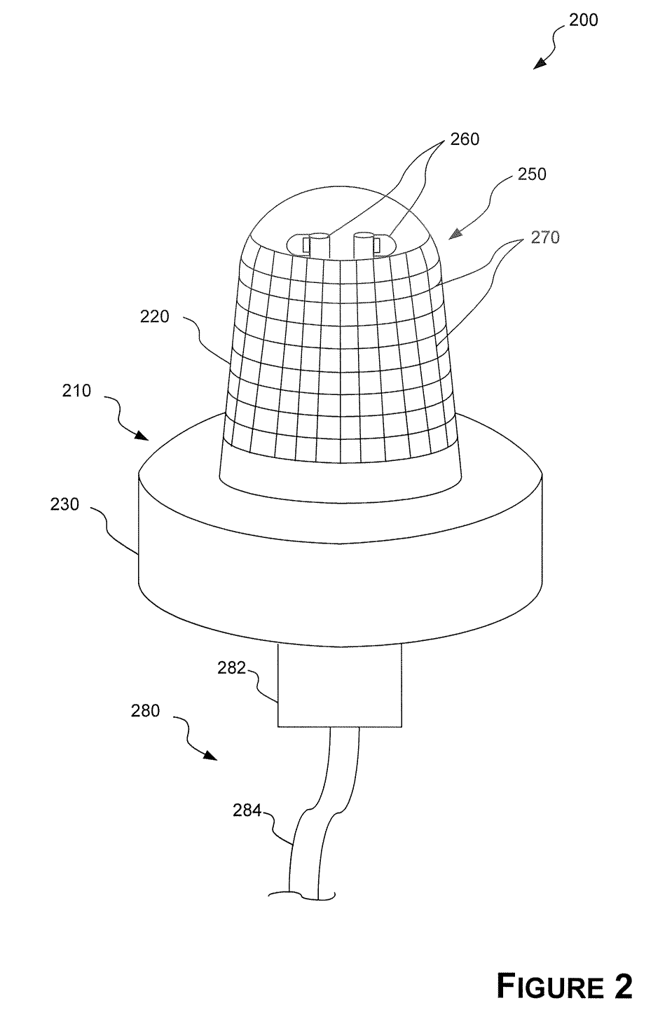

FIGS. 1 and 2 illustrate warning lights 100 and 200, respectively, representing exemplary implementations of the present disclosure. The warning light 100 of FIG. 1 is a self-contained, direct current (DC) warning light. The warning light 200 of FIG. 2 is an externally-powered warning light configured, for example, to receive power from an alternating current (AC) source, such as provided by a power utility or a portable generator. Both employ heat-dissipating LED arrays and a pulsated power signal to power the LED arrays, as are further described below.

The warning light 100 includes a housing 110 for containing the light assembly 150 and protecting it from weather and other ambient conditions. The housing 110 includes a transparent or translucent dome 120 to protect the light assembly 150 while transmitting the warning light signals generated by the warning light. The dome 120, in one implementation, is comprised of heat and impact resistant glass that protects the light assembly 150. The dome 120 withstands the heat the light assembly 150 generates without melting or losing its transparency as a result of exposure to heat. Alternatively, plastics or other transparent or translucent natural or manmade materials may be used to create the dome 120.

The housing 110 also includes a base 130. The base 130 desirably is formed of a corrosion- and impact-resistant material to resist the damaging effects of weather and wear. In one implementation, the base 130 is cast from corrosion-resistant aluminum, thus causing the base 130 to be durable and resistant to the effects of weather or other moisture, yet relatively light in weight. Aluminum also is a heat-dissipating material, which is beneficial in dispersing heat generated by the warning light 100 and, thus, effectively reducing the operating temperature of the warning light 100. Alternatively, the base 130 may be formed from other metals, plastics, ceramics, composites, or other materials. The base 130 may be painted to provide further protection against moisture, as well as to enhance the visibility of the warning light 100.

In the implementation shown in FIG. 1, the base 130 includes an upper section 132 and a bottom section 134 that are joined with a flanged coupling 136. The flanged coupling 136, which may be integral within either the upper section 132 or the lower section 134 of the base 130, may be internally threaded to receive an externally-threaded opposing section. The sections 132 and 134 are joined by rotating the upper section 132 and the lower section 134 relative to each other to screw the sections 132 and 134 together. The upper section 132 and the lower section 134 also could be secured to one another using latches or other types of fasteners. Allowing for the sections 132 and 134 of the base to be opened and closed with relative ease facilitates replacing batteries or making operational mode changes.

An internal gasket (not shown in FIG. 1) or other seal that blocks moisture or particulates from entering the base 130 through the coupling 136 is desirable to protect the light assembly 150 and the supporting components. Additionally, an airtight gasket or seal that prevents ambient gases from flowing into the housing may be used to adhere to safety standards for environments in which combustible gases may be present.

The dome 120 is joined to the base 130 with a coupling 140. The coupling may include a machined flame path, as are used for sealing joints to prevent the leakage of fluids and gases and desirable when the warning light 100 may be deployed where combustible materials are present. In addition to sealing the joint against passage of fluids or gases, it is desirable that the coupling be both durable and moisture-resistant to protect the light assembly 150 and other components from the potentially damaging effects caused by weather and other operating conditions.

In one possible implementation, a control system (not shown in FIG. 1) for the warning light 100 is contained in the base 130 while the light assembly 150 is positioned inside the dome 120. As further described in detail below, the lighting assembly 150 includes one or more heat-dissipating LED arrays 160. Each of the heat-dissipating LED arrays 160 includes a plurality of LEDs coupled with or otherwise disposed against a heat-dissipating mechanism such as a heat sink or a heat pipe as further described below. The number of LED arrays 160 used may depend on the desired application for the warning light 100. For example, for a highly directional application, one or two LED arrays 160 disposed with the LEDs facing in the direction in which the warning light signal is to be given may be sufficient.

A directional implementation may be suitable, for example, for a warning light to be mounted on a door or a wall. On the other hand, for a warning light 100 to be mounted on a ceiling or in any context in which it is desirable for the warning signal to be cast throughout a range of directions, it may be desirable to include four or more LED arrays 160 to cast the warning signal throughout a full 360-degree range of an area. Only two LED arrays 160 are shown in FIG. 1 for the sake of visual simplicity. However, for a dome-style warning light 100, more than two LED arrays 160 may be desirable.

To enhance the effectiveness of the warning light signal, in one possible implementation, the lighting assembly 150 is disposed within a lens 170. The lens 170 is secured in place on the dome 120 and/or the base 130 with one or more brackets formed in or attached to the dome 120 and/or the base 130. The lens 170 desirably may include a Fresnel-type lens to allow for the lens 170 to be relatively thin and light in weight, may be used to effect a desired dispersion of the warning light signal. For example, the lens 170 may be used to diffuse the light generated by the LED arrays 160 to increase the angular coverage of the light generated by the light assembly 150. Alternatively, the lens 170 may be shaped to collimate the light generated by the LED arrays 160 to increase the visible range of the light cast by the warning light 100.

In addition, the color of the lens 170 may be selected to match the spectrum passed by the lens 170 to that of the light generated by the LED arrays 160, or vice versa. Matching the light-passing spectra of the lens 170 and the light-generating spectra of the LED arrays 160 maximizes light intensity efficiencies, allowing for relatively bright warning light with reduced power consumption. For example, if the selected LED arrays 160 produce white light, but the lens 170 passes red light, the lens 170 would absorb non-red light, wasting light produced by the LED arrays 160. On the other hand, if the selected LED arrays produce red light and a red lens 170 is employed, the lens will maximally pass the light generated by the LED arrays 160.

Exploiting the capability of LEDs to generate light in sections of the visible spectrum is another advantage of using LEDs instead of incandescent lights. Incandescent light bulbs produce broad spectrum light that appears as white light. When red, amber, green, or other colors of light are desired when using an incandescent light, the incandescent light is filtered so that only the desired color of light is passed. Producing colored light from incandescent light thus wastes at least a portion of the light generated. By contrast, because LEDs emit light in a specific section of the spectrum, matching the color of light generated by the LED arrays 160 and the color of the lens 170 to the color desired for an application means that more of the light generated is passed.

FIG. 2 shows a warning light 200 that, while similar to the warning light 100 (FIG. 1) in many respects, also features some notable differences. The warning light 200 also includes a housing 210 that includes a dome 220 and a base 230 that house and protect a lighting assembly 250 and its supporting components (not shown). The lighting assembly 250, like the light assembly 150, includes a plurality of heat-dissipating LED arrays 260 to produce a warning light signal.

There are two specific differences to note between the warning light 100 (FIG. 1) and the warning light 200. First, the warning light 200 receives an external power source 280, such as an AC current supply, to power the lighting assembly 260 and its supporting controls. The housing 230 includes a coupling (not shown in FIG. 2) to receive a power connector 282 that joins the warning light 200 to a power supply line 284. An externally-powered warning light 200 may be desirable for applications in which the warning light is permanently mounted on a wall or other surface to warn persons of a continuing or intermittent condition at that location that may be hazardous. In a non-permanent context, an externally-powered warning light provides some advantages in that one need not periodically open the housing 230 to replace or check the batteries. Also, because the warning light 200 relies on external power, the warning light 200 can be turned on or off by coupling and decoupling, respectively, the external power source 280 to the warning light 200. The external power source 280 can be AC current, such as produced by an electric utility or a generator.

Second, in the warning light 200, the lens 270 is integral with the dome 220. Thus, instead of using a separate lens to be secured by the dome 220 and/or the base 230, the dome 220 is molded to form the desired lens structure. In addition, the dome 220 is formed of glass or another material passing the desired color of light to take advantage of the efficiency gained by matching the color of the lens with the spectrum of light generated by the LED arrays 260 as previously described.

### Use of Heat-Dissipating LED Arrays

As previously described, if LEDs are subjected to excessive heat, the light intensity emitted by the LEDs decreases, and the LEDs may become damaged and/or fail. To protect the LEDs from the negative and potentially damaging effects of heat buildup, possible implementations of this disclosure employ LED arrays configured to dissipate heat. According to one possible implementation of this disclosure, heat is dissipated by coupling the LEDs to a heat sink. In one particular implementation, the dies of the LEDs are coupled with a heat pipe which provides rapid, efficient cooling.

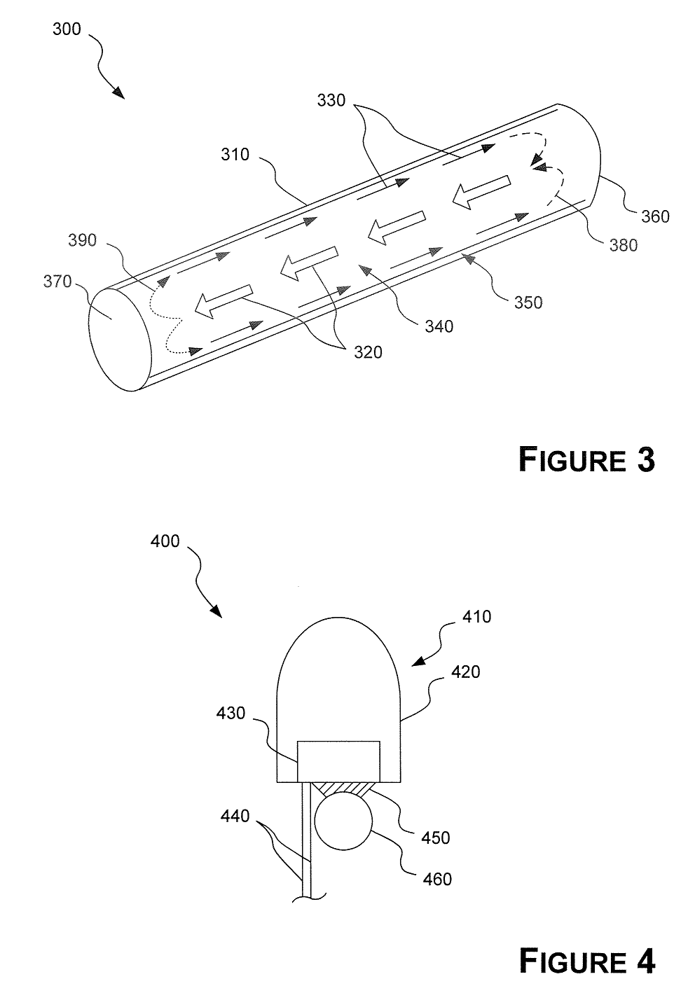

FIG. 3 is a cutaway view of a cylindrical heat pipe 300. Heat pipes also may take planar or other forms that will facilitate the same functionality described below. The heat pipe 300 includes a sealed, elongated housing 310. The housing 310 preferably is formed of a material that rapidly absorbs and conducts heat, such as copper or aluminum. Inside the housing 310 is a fluid that, when the heat pipe 300 is in operation, exists in both a gaseous state, with the gas represented by a plurality of large, hollow arrows 320, and a liquid state, with the liquid represented by a plurality of narrow, solid arrows 330. In operation, the gas 320 flows through a central area 340 of the housing 310, while the liquid flows along walls of the housing 310 in a wicking area 350. The wicking area 350 may be manifested as longitudinal channels formed along the length of the interior of the housing, or as a channel or another structure or substance configured to exploit capillary action to draw the liquid 330 through the housing 310 of heat pipe 300.

In operation, a first end 360 of the heat pipe 300 is disposed against or adjacent an object to be cooled. A second end 370 of the heat pipe 300 is positioned against or adjacent to a relatively cool temperature reservoir, such as the ambient environment or another cooling system. The liquid 330 flows through the wicking area 350 toward the first end 360 where the liquid 330 absorbs heat through the first end 360 of the housing 310. When the liquid 330 absorbs sufficient heat, the liquid 330 evaporates—as represented by the dashed lines 380 into a gas 320. The evaporation 380 of the liquid 330 provides cooling to the area against which the heat pipe 300 is disposed. The gas 320 then flows away from the first end 360. In some implementations, the heat pipe 300 is deployed with the first end 360 below the second end 370 of the heat pipe 300. This arrangement takes advantage of gravity to draw the liquid 330 toward the first end 360 and facilitate the lighter gas 340 flowing toward the second end 370 of the heat pipe.

As the gas 320 nears or reaches the second end 370 of the heat pipe 300, the gas 320 condenses into a liquid 330, as represented by the dotted lines 390. The condensation 390 discharges the absorbed heat through the second end 370 of the heat pipe 300. The heat pipe 300 thus acts as a self-contained temperature exchanger.

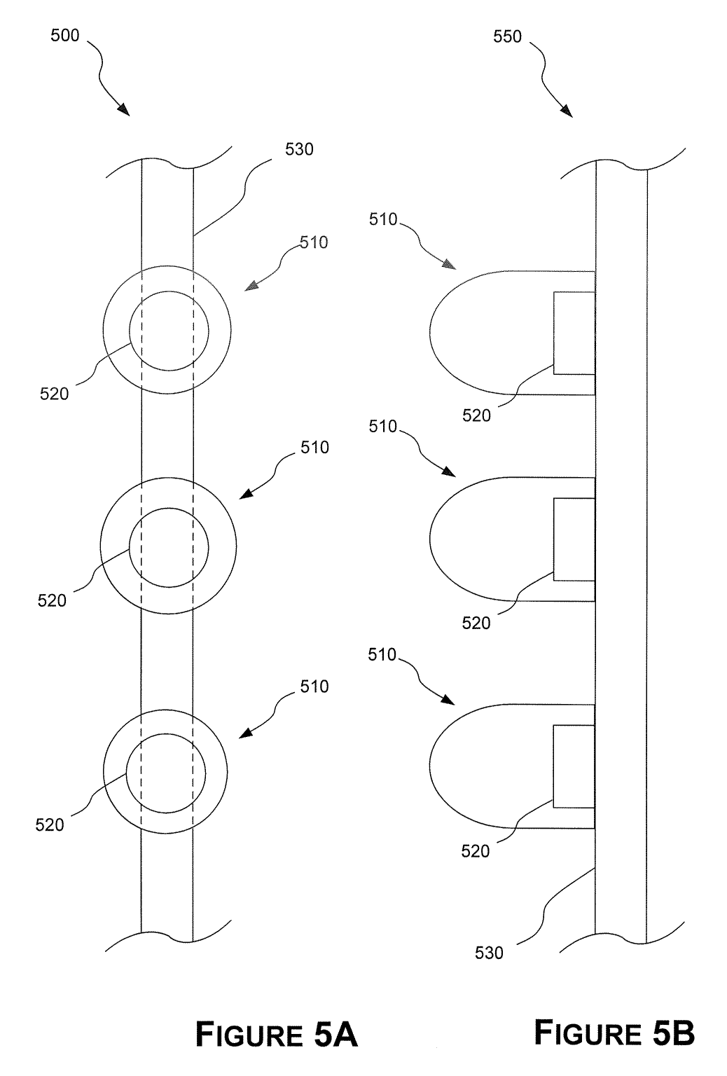

Although the heat pipe 300 is described as absorbing heat at a first end 360 and discharging or dissipating the heat at an opposing, second end 370, it should be noted that the heat transfer is not limited to taking place only at the ends 360 and 370 of the heat pipe 300. As understood by those with knowledge of the use of heat pipes 300, heat is absorbed along a length of the heat pipe 300 toward the first end 360 and discharged along a length of the heat pipe 300 toward the second end 370. Thus, as will be described with reference to FIGS. 5 through 7, a heat pipe 300 can be used to draw heat from LEDs at a first end 360 of the heat pipe 300 and be discharged along a length of the heat pipe 300 toward the second end 370 of the heat pipe 300.

FIG. 4 shows a cross-sectional view of an apparatus 400 including an LED 410 coupled to a heat-dissipating apparatus 460. The LED 410 generally includes a transparent or translucent casing 420, the diode apparatus 430, a lead frame 440, and a die 450 on which the diode apparatus is situated. The diode apparatus 430 includes the diode itself, which may be mounted over a reflector and/or beneath a lens (none of which is specifically shown in FIG. 4) to disperse or collimate the light generated by the diode as desired. Alternatively, a lens to direct the light produced by the diode may be integrally formed as part of the casing 420. The diode apparatus 430 is connected to a lead frame 440 including an anode and a cathode for supplying electrical power to the diode apparatus. The die 450 is the base of the LED 410. In FIG. 4, the die 450 is shown as adapted to engage the surface of the heat-dissipating apparatus 460. It is desirable to provide as much common surface area between the die 450 and the heat-dissipating apparatus 460 to improve the transfer of heat from the LED 410 to the heat-dissipating apparatus 460.

In FIG. 4, the heat-dissipating apparatus 460 is shown in cross-section. The heat-dissipating apparatus 460 may include a heat pipe as described in reference to FIG. 3, or another type of heat sink. In possible implementations of the present disclosure, multiple LEDs 410 are disposed along the surface of the heat-dissipating apparatus 460. Disposing the LEDs 410 along the surface of the heat-dissipating apparatus 460 allows for multiple LEDs to operate in close proximity to one another without suffering negative effects of heat buildup, because the heat-dissipating apparatus 460 carries away heat from the LEDs 410.

Although in FIGS. 3-7 the heat-dissipating devices are shown as longitudinal devices, the heat-dissipating devices also could include planar heat sinks or longitudinal devices arranged in a heat-dissipating surface to conduct heat away from a plurality of LEDs 410.

FIGS. 5A and 5B show views of portions of linear sections of heat-dissipating LED arrays used in possible implementations of the present disclosure. In FIG. 5A, the LEDs 510 are shown in a cutaway view to illustrate the relationship of the LEDs 510 to a heat-dissipating device 530. FIG. 5A shows a top-view of a portion of an array 500 of three LEDs 510 positioned along a section of a heat-dissipating apparatus 530. The dies 520 of the LEDs are disposed against a surface of the heat-dissipating device 530 to transfer heat from the dies 520 of the LEDs 510.

FIG. 5B shows a side view of an array 550 of three LEDs 510 mounted on a heat-dissipating device 530. As shown in the side view of FIG. 5B, the dies 520 of the LEDs 510 each are disposed against the heat-dissipating device 530 to maximally transfer heat from the LEDs 510 to the heat-dissipating device 530. Because of the lead frames (not shown in FIGS. 5A and 5B), the shape of the heat-dissipating device 530, and other physical considerations, it may not be possible to mount the dies 520 of the LEDs 510 fully against the heat-dissipating device 530. The more surface contact and/or proximity exiting between the dies 520 and the LEDs 510 improves the thermal transfer between the LEDs 510 and the heat-dissipating devices 530. The LEDs 510 may be mounted on the heat-dissipating devices 530 with fasteners or adhesives (that, desirably, do not remove or separate the dies 520 from the surface of the heat-dissipating devices). Alternatively, the LEDs 510 may be joined to one another and be positioned against the heat-dissipating devices 530 by the geometry of the device in which the array 550 is used.

Although not shown in FIGS. 5A and 5B, the heat-dissipating devices 530 will be coupled with a plurality of LEDs 510 toward one end of each of the heat-dissipating devices, while an opposing end of the heat-dissipating devices 530 will be disposed in a position to discharge absorbed heat. In implementations further described below, the heat-dissipating devices extend away from the LED arrays into a housing of the warning lights and/or are disposed against the surface of the housing to facilitate the dissipation of heat.

### Configuration of Warning Lights Using Heat-Dissipating LED Arrays

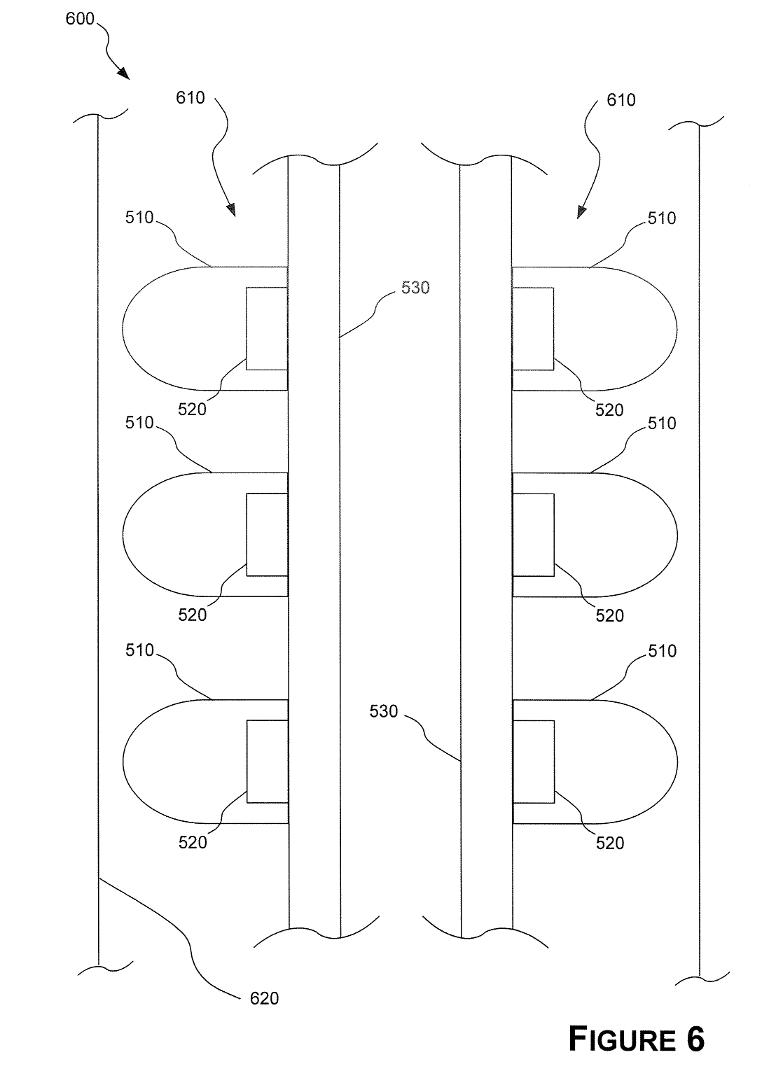

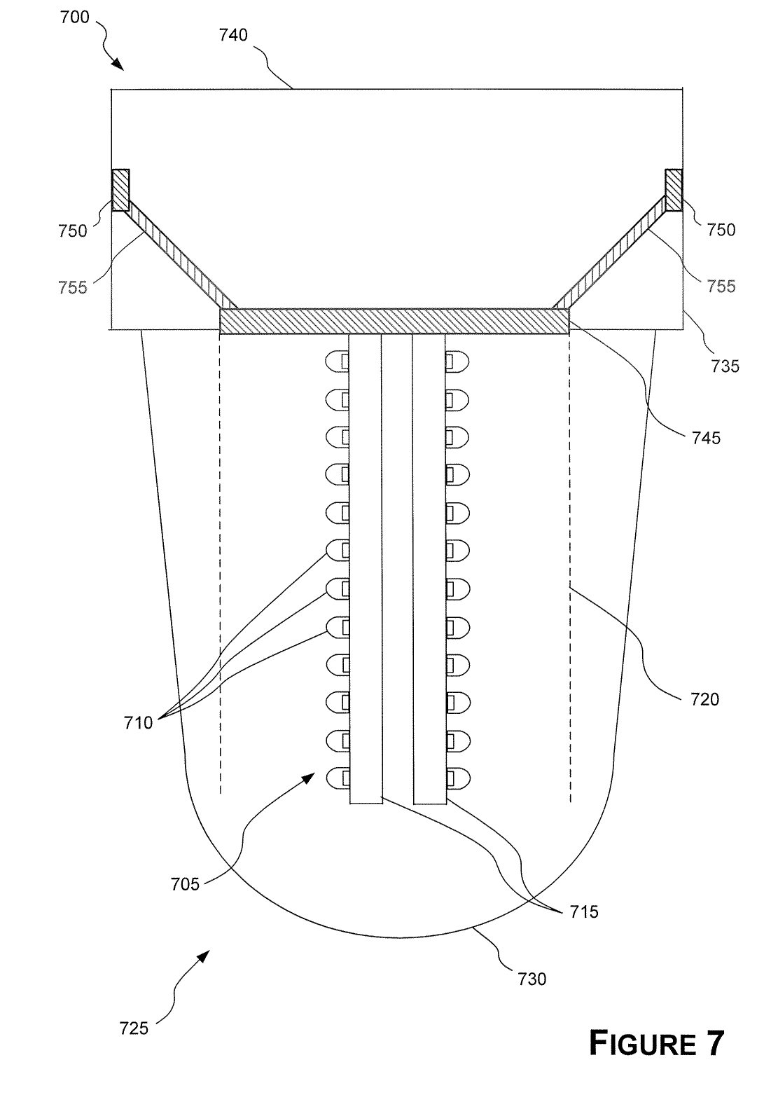

FIGS. 6 and 7 illustrate possible implementations of the present disclosure for presenting warning lights using heat-dissipating LED arrays. FIG. 6 shows a cross-sectional view of a light assembly 600 showing the use of two opposing LED arrays 610. The LED arrays 610 each include three LEDs 510 mounted with the dies 520 of the LEDs 510 disposed against a heat-dissipating device 530. The heat-dissipating devices 530 extend away from the LEDs 510 to carry heat away from the LEDs 510.

In FIG. 6, the two opposing LED arrays 610 generate light in opposing directions to increase the visible range of an apparatus using the LED arrays 610. Additional LED arrays (not shown) could be positioned orthogonally relative to the LED arrays shown 610 to generate light, relative to the frame of reference of FIG. 6, to the left and right, outward from FIG. 6, and inward into FIG. 6 to provide wide coverage. As many LED arrays 610 as desired could be used. Thus, for example, if the LED arrays 610 were to be used in a warning light or other device, and maximum coverage of a 360-degree area was desired, an LED array 610 could be included for each 45 degrees, 30 degrees, 20 degrees, 10 degrees, etc., of angular coverage to provide the desired light intensity over the scope of desired coverage.

FIG. 6 also shows a lens 620 in which the light assembly 600 is disposed, as described with reference to FIG. 1. The lens 620, in one possible implementation, is an annular, Fresnel-type lens formed to direct the light generated by the LED arrays 610 in a desirable pattern. In one possible implementation, the lens 620 generally maintains a collimation of the light generated outwardly from each of the LEDs 510 (to the left and right, relative to the orientation of FIG. 6), but may disperse the light along a perpendicular axis (perpendicular relative to the surface of FIG. 6) to improve the angular coverage provided by the LED arrays 610.

As previously described, it is desirable to match the light-passing spectrum or color of the lens 620 to the light generated by the LEDs 510. For example, if the LEDs 510 generate red, green, or amber light, choosing a red, green, or amber lens 620 efficiently passes the light generated by the LEDs 510. When using a lens integral to the dome of a warning light housing, as described with reference to FIG. 2, the dome should be formed of a material passing light of the same color generated by the LEDs. In addition, the dome should be formed to act as a lens to distribute light as desired relative to the orientation of the LED arrays 610.

FIG. 7 is a cross-sectional view of a warning light 700 using a plurality of LED arrays 705. The warning light 700, which is vertically-oriented opposite to the orientation of the warning lights 100 and 200 of FIGS. 1 and 2, respectively, shows that warning lights according to possible implementations of the present disclosure are not limited to being mounted with a base of the warning light 700 at the bottom. The base 735 of the warning light 700 could be mounted with the LED arrays 705 above the base, below the base, or, if the warning light is mounted on a wall, for example, extending laterally away from the base.

For the sake of visual simplicity, two LED arrays 705 are shown in FIG. 7. However, as previously described, several LED arrays 705 could be used to provide the desired angular coverage of the warning light 700.

Each of the LED arrays 705 includes a dozen LEDs 710, each of which is mounted on and/or disposed against a heat-dissipating device 715. The choice of showing twelve LEDs 710 in each LED array 705 is somewhat arbitrary, but the choice exemplifies that many LEDs 710 can be disposed in each of the LED arrays 705 to produce the desired coverage and light intensity.

The LED arrays 705 and, in the implementation shown in FIG. 7, a separate lens 720 are received in a housing 725. The housing 725 includes a transparent or translucent dome 730. As previously described, it is desirable to efficiently transfer the light generated by the LEDs 710. Thus, if a colored lens 720 is used, the dome 730 desirably is colorless so as not to absorb light generated by the LEDs 710, or the dome 730 may be matched to the color of light generated by the LEDs 720. If a separate lens 720 is not used, the dome 730 should be matched in color to the light generated by the LEDs 710.

The housing 750 also includes a base 735, as previously described. The dome 730 and the housing 735 are, in possible implementations of the present disclosure, mounted in sealable arrangement to protect the LED arrays 705 and the supporting components (described below) from moisture, particulates, or other environmental concerns. As previously described, sealing the warning light 700 also serves to contain the heat generated by the LEDs 710. However, the heat-dissipating devices 715 channel the heat away from the LEDs 710 to prevent the negative and potentially damaging effects of heat buildup.

In one possible implementation shown in FIG. 7, the heat-dissipating devices 715 are thermally coupled with the base 735 at an end of the warning light 700 away from the LEDs 710. In a possible implementation in which the base 735 is formed of a heat-conductive material, such as aluminum, base 735 as a whole acts as a heat sink to assist in the dissipation of heat carried from the LED arrays 705 by the heat-dissipating devices 715. If the warning light 700 is mounted at an end 740 of the base 735 to a heat-dissipating surface, such as a metal wall, for example, heat dissipation may be further improved.

As shown in FIG. 7, the heat-dissipating devices 715 are mounted on a base plate 745 which, desirably, is formed of a heat-dissipating material such as aluminum. The base plate 745 is coupled to one or more couplings 750 in the base 735 of the housing 725 by a corresponding number of thermal brackets 755. The thermal brackets 755 facilitate the dissipation of heat from the heat-dissipating devices 715 through the base plate 745 to the housing 725 to disperse heat build-up in the warning light 700. Dispersal of the heat provides for a higher T-code rating allowing the warning light 700 to be deployed in environments even where operating temperatures are strictly limited as previously described.

Although not shown in FIG. 7, the end 740 of the base 735, or other surfaces of the base 735, may be equipped with mounting brackets configured to mount the warning light 700 on a number of surfaces or objects. The warning light 700, particularly when oriented as shown in FIG. 7, could be mounted on a ceiling using a suitable bracket disposed on the base 735. Alternatively, the warning light could be mounted on a wall, on a floor, on a pedestal, clamped to a sign or barricade, or any other object using suitable brackets.

In possible implementations of the warning light 700, the warning light 700 is configured to be used as a Class 1, Division 1 with a T-code T6 rating as described further below. The warning light 700 meets the requirements of Titles 33 and 46 of the current Code of Federal Regulations that dictate the operational requirements for such devices. Possible implementations of warning lights using heat-dissipating LED arrays can match or exceed the light intensity generated by a 100 watt incandescent bulb through a colored lens.

### Exemplary Control Circuitry for Possible Implementations of Warning Lights

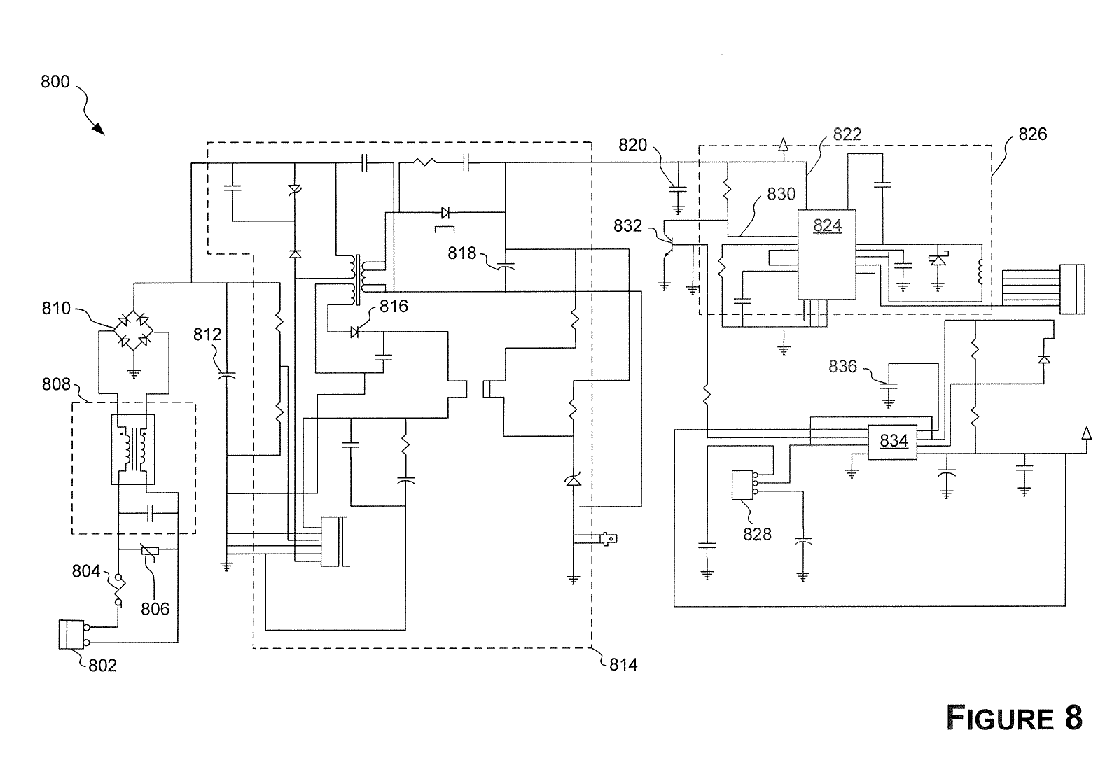

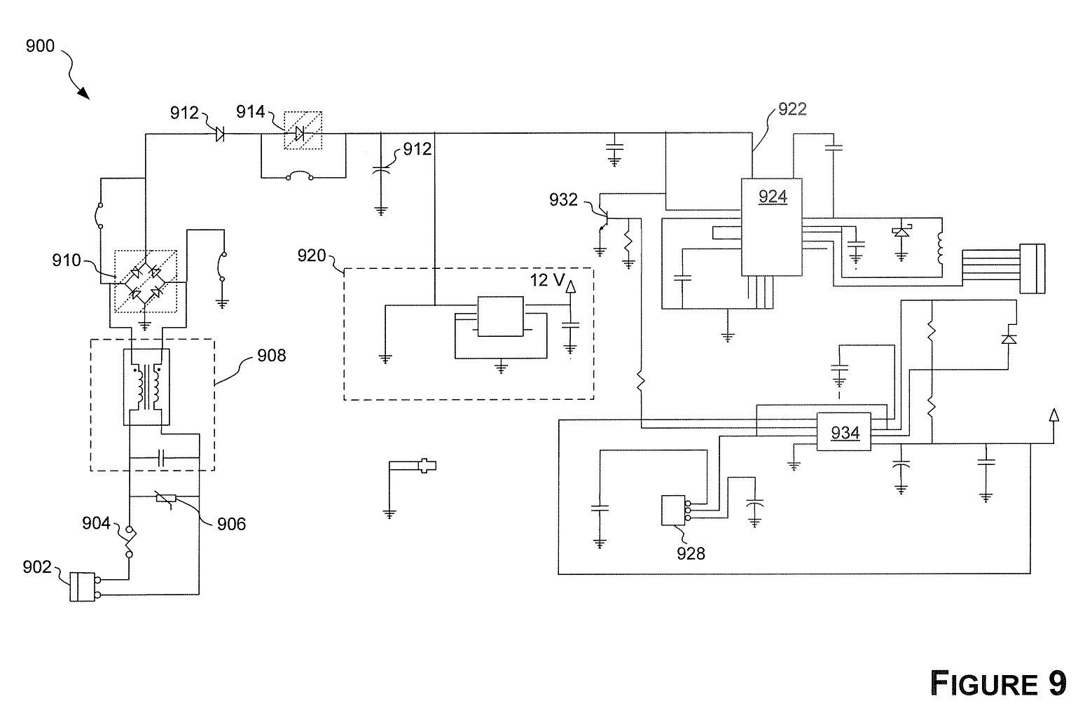

FIGS. 8 and 9 are schematic diagrams of control systems 800 and 900, respectively, suitable for use with warning lights employing heat-dissipating LED arrays. It should be noted, however, that the control systems 800 and 900 illustrate only exemplary control systems, and possible implementations of the present disclosure are not limited to using control systems such as the exemplary control systems 800 and 900.

The control systems 800 and 900 of FIGS. 8 and 9, respectively, are configured to generating a pulsating power signal to the LED arrays. The control systems 800 and 900 are provided by way of example, not by way of limitation, to illustrate possible implementations of applying a pulsating power signal to a light source to reduce the heat produced by the light source and the operating temperature of the warning light.

When power is supplied to a light source, the light source generates light and heat. Applying a constant source of power to a light source generates a constant light signal, but also continually generates heat. Applying a pulsating power signal to the light source will result in a pulsating light signal because the light source will pulse on and off in accordance with the power signal applied. Just as the light source will generate a light signal that pulsates, however, the heat produced will also pulsate in accordance with the power signal. Thus, applying a pulsating power signal to a light source reduces the heat the light source produces.

Some warning light applications or other light applications, require a continually on, steady-state light signal. In addition, the light produced by the light source must meet a predetermined threshold intensity. However, a pulsating light source can meet these requirements if the light source is pulsated sufficient rapidly as to appear to be a steady-state light signal and if the light source is bright enough so that, while being pulsated, the average light output meets the threshold intensity level.

A pulsating power signal of, for example, 500 Hz, cycling between equal power-on and a power-off signals, will generate a light signal that, to a human eye, appears to be a steady-state signal that will satisfy safety standards that require a steady-state light signal. An evenly-pulsating power signal thus can provide a desired level of light intensity while reducing the energy consumed by the light source and the heat it produces.

An evenly-pulsating signal as previously may be sufficient for many applications. However, in the case of an application requiring a T-code of T6, an evenly-pulsating power signal of 500 Hz may not suffice. For example, it is desired to generate the same light output as a 100 Watt incandescent bulb, pulsating an LED capable of generating the same light output using a 500 Hz evenly-pulsating signal may produce too much heat to receive a T-code of T6. Lowering the frequency of the evenly-pulsating signal will reduce the heat generated. However, even if the light source provides a sufficient light output at the reduced frequency, reducing the frequency sufficiently to reduce the heat output may result in the light appearing to flicker. For example, upon reducing the frequency of the evenly-pulsating signal to 120 Hz or less, the light may appear to a human eye to be pulsating, and thus will not meet the objective of providing a steady-state light signal.

Using pulse-width modulation to vary the on-time and off-time of the pulsating power signal, however, allows the frequency of the pulsating power signal to be reduced sufficiently to reach temperature output targets while still producing an apparently steady-state light signal. For example, generating a pulse-width modulated signal having a frequency between 90 Hz and 100 Hz and having an on-time of 60 percent to 70 percent and a corresponding off-time of 40 percent to 30 percent yields an apparently steady-state light signal. Specifically, at a frequency of 95 Hz and an on-time to off-time ratio of 65 percent to 35 percent, every 10.5 milliseconds, the light source will appear to be on for 6.8 milliseconds and off for 3.7 milliseconds. To a human eye, the light will appear to be constantly on. In addition, use of the pulse-width modulated signal results in a sufficient reduction in heat generation to support applications requiring even a T-code of T6.

As described with reference to the control systems 800 and 900 of FIGS. 8 and 9, respectively, one implementation of generating a suitable pulse-width modulated signal to an LED array uses a solid-state timer, such as a 555 timer chip, to cause an input signal to be applied to the on/off or shutdown (SHDN) pin of an LED driver. In the implementations illustrated in control systems 800 and 900, the output signal of the solid-state timer is applied to a base of a transistor which, in turn, applies the pulse-width modulated power signal to the SHDN pin of the LED driver. It will be understood by those ordinarily skilled in the art that including the transistor may be desired or necessary to provide a signal of sufficient current to the SHDN pin of the LED driver. The LED driver may require an input signal having a higher current at the SHDN pin than the current output solid-state timer provides.

Those ordinarily skilled in the art also will appreciate that the implementations of the control systems 800 and 900 of FIGS. 8 and 9 could be implemented in a number of ways to generate a suitable pulse-width modulated signal. In addition, those ordinarily skilled in the art will appreciate that a solid-state timer, such as a 555 timer, can be configured to generate a desired pulse-width modulated signal by varying resistance and capacitance values of resistors and capacitors, respectively, coupled to appropriate pins of the 555 timer. In any case, implementations of the present disclosure are not limited to any particular devices or any particular configurations herein described.

FIG. 8 shows a schematic diagram for an AC-powered control system 800 suitable for use with an externally-applied source of AC power. Functional elements of the schematic diagram of the control system are described, but the purpose of each and every component shown in the schematic diagram is not described; the function of individual resistors, capacitors, and other components is understood by those ordinarily skilled in the art of circuit design.

The AC power, which in one implementation may include 120 volts AC or 240 volts AC, is received at a jumper 802. A fuse 804 protects the control system 800 against excessive power input. A variable resistor 806 also provides transient power protection for the control system 800. An electromagnetic interference (EMI) filter 808 receives the input power and applies the power to a bridge rectifier 810. Any ripples in the power output of the bridge rectifier 810 are smoothed by capacitor 812, and the resulting output is supplied to universal input off-line switch mode power supply circuit 814. The universal input off-line switch mode power supply circuit 814, in the implementation shown, operates at 132 kHz and converts a relatively high DC voltage at capacitor 812 to approximately 12 volts. The output low voltage is rectified by diode 816 and filtered by capacitor 818 to reduce current ripples.

The DC output generated by the switch mode power supply is applied to capacitor 820 and a signal input pin 822 of LED driver 824. The LED driver 824 is a part of a high frequency, switching DC-to-DC converter 826 operating in a range of 450 to 500 kHz. The output of the DC-to-DC converter 826 generates an LED operating voltage at a constant current of approximately 1 amp. The output voltage of the DC-to-DC converter may be changed for different color LED modules, but in one possible implementation, the output current remains constant at approximately 1 amp.

The control system 800 supports operation of the warning light in either a steadily-blinking or steady mode or a flash mode. When jumper 828 is set to a STEADY position, a shutdown or SHDN pin 830 of the LED driver 824 is controlled by transistor 832 and solid-state timer 834. In one implementation, as previously described, the timer 834 is a standard, 555 timer that, when configured to generate a pulse-width modulated signal effecting a desired steady-state mode, produces 90 to 100 pulses per minute during which the output is on for approximately 65 percent of each cycle and off for approximately 35 percent of each cycle. The output of the timer 834 controls the base of the transistor 832, which is configured to operate as a switch to cause the SHDN pin 830 of LED driver 824 to be on for approximately 65 percent of the cycle and off for approximately 35 percent of the cycle.

On the other hand, when the jumper 828 is set to a flash mode, capacitor 836 is coupled to the timer 834, changing the output of the timer 834 to cycle approximately 60 times per minute with an output that is on approximately 50% of the cycle and off approximately 50% of the cycle. Correspondingly, the output of the time 834 causes the transistor 832 and, thus the SHDN pin 830 of LED driver 824 to cycle at this rate.

FIG. 9 shows a control system 900 configured to receive DC input, such as might be received in a standalone, sealed warning light. Input power, which in one implementation is 24 volts DC, is received at a jumper 902. In one implementation, the jumper 902 receives the input power from one or more batteries that may be housed within the base of the warning light. A fuse 904 protects the control system 900 against excessive power input. A variable resistor 906 also provides transient power protection for the control system 900. It should be noted that the DC input at the jumper 902 is not polarity sensitive.

The operation of the LED driver and timer circuit in control system 900 is similar to that of the AC-powered control system 800 (FIG. 8), although the circuitry is simplified in that AC power need not be converted to DC power. When a 24-volt DC input is applied to the jumper 902, it is passed through EMI filter 908, rectifier bridge 910, diodes 912 and 914. The output of the rectifier diode 914 is applied directly to the signal input pin 922 of LED driver 924 and a linear voltage regulator circuit 920. The linear voltage regulator circuit 920 is configured to generate a 12-volt DC output that is used to power the timer circuit 934. The timer circuit 934 operates similar to that described with reference to the control system 800 of FIG. 8, in that the setting of jumper 928 controls the output of the time 934 and transistor 932 to control the output of the control system 900.

### Process for Generating a Warning Light Signal

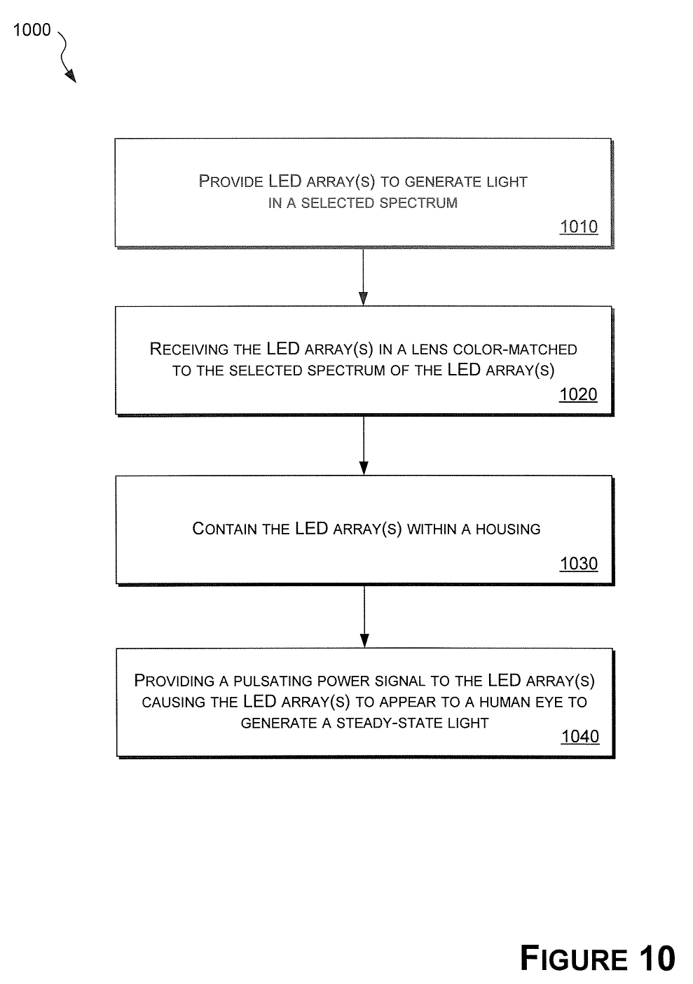

FIG. 10 presents a flow diagram 1000 for one possible implementation of a method for generating a warning light signal having a sufficient light intensity and a reduced heat output to meet predetermined application levels. At 1010, one or more LED arrays are provided to generate light in a selected spectrum for a desired application. As previously described, safety codes such as the Code of Federal Regulations may dictate a minimum level of light intensity and/or color required for a warning light. Other safety standards or practical concerns also may dictate a desired level of light intensity. To take one example, possible implementations of the present disclosure replace a 100 watt incandescent light bulb with a number of LEDs operable to produce the same light intensity as the incandescent bulb they replace. The light intensity desired may include not only overall light intensity, but its direction; thus, as previously described, LEDs may be arrayed in a pattern to provide the desired level of light intensity over a range of directions.

At 1020, LED arrays are received in a color-matched lens configured to pass light in the same selected spectrum at which the LED arrays generate light. As previously described, color-matching the lens (which may or may not be integrated with a dome of a warning light housing) provides greater efficiency in light generation. As a result, LEDs passing light through a lens of matching color may be able to match the light output of an incandescent light filtered by a colored lens while consuming significantly less power, as previously described. The lens selected also may be configured to control the collimation or dispersion of the light generated in one or more directions, as previously described. The lens may include a separate lens or a lens integrated with a dome or other light-transmitting housing in which the LED arrays may be disposed.

At 1030, the LED arrays are contained within a housing. The housing should meet considerations appropriate for the selected application. At 1040, a pulsating power signal is provided to the LED arrays, causing the LED arrays to appear to a human eye to generate a steady-state light signal. As previously described, the LED arrays selected, the lens, the frequency and on-time/off-time ratio of the pulsating power signal, and characteristics of the housing may be selected to meet operational considerations, such as desired T-code ratings or to satisfy Class and Division requirements.

The above specification, examples and data provide a complete description of the manufacture and use of the composition of the invention. Because many embodiments of the invention can be made without departing from the spirit and scope of the invention, the invention resides in the claims hereinafter appended.

1. A warning light, comprising:
a control system configured to receive a power supply and generate a pulsating output;
at least one light-emitting diode (LED) array configured to receive the pulsating output and generate a pulsating light having a predetermined intensity and appearing to a human eye to include a steady-state light; and
a housing configured to contain the warning light, including:
a base configured to contain the control system and receive the power supply;
a light-conductive dome configured to receive the LED array; and
a coupling configured to join the dome to the base.

2. The warning light of claim 1, wherein the predetermined intensity satisfies Class 1, Division 1 standards.

3. The warning light of claim 1, wherein the control system is configured to generate the pulsating output using pulse width modulation, including:
an operating frequency of approximately 90 Hz to 100 Hz; and
an on-time of approximately 60 percent to 70 percent.

4. The warning light of claim 3, wherein the control system includes:
an LED driver circuit configured to apply power to the LED array when an on signal is applied to a shutdown (SHDN) input voltage; and
a solid-state timer configured to generate an output signal configured to cause the on signal to be applied to the shutdown input voltage of the LED driver.

5. The warning light of claim 1, further comprising a lens configured to be disposed around the LED array.

6. The warning light of claim 5, wherein the lens is color-matched to transmit light in a spectrum matching a spectrum of light generated by the LED array.

7. The warning light of claim 5, wherein the lens is configured to one or more of:
collimate light generated by the LED array in at least one dimension; and
disperse light generated by the LED array in at least one dimension.

8. The warning light of claim 8, wherein the lens is integrated with the dome of the housing.

9. The warning light of claim 1, wherein the warning light radiates a temperature within a specified temperature range.

10. The warning light of claim 9, wherein the specified temperature output satisfies a T-code T6 standard.

11. The warning light of claim 1, wherein the LED array includes a heat-dissipating LED array, including:
a plurality of LEDs, and;
a heat-dissipating device configured to be disposed one of against or adjacent to the plurality of LEDs and dissipate heat generated by the LEDs.

12. The warning light of claim 11, wherein the heat-dissipating device includes a heat pipe.

13. The warning light of claim 11, wherein:
the heat-dissipating device is thermally coupled to the base of housing such that the heat-dissipating device is configured to absorb heat generated by the LEDs and transfer the heat to the base of housing; and
the base of the housing includes a heat-dissipating material.

14. The warning light of claim 13, wherein the heat-dissipating material of the base of the housing includes aluminum.

15. The warning light of claim 1, wherein the control system is configured to receive the power supply from one of:
one or more batteries accommodated within the base of the housing;
an external direct current (DC) power source; and
an external alternative current (AC) power source.

16. A warning light, comprising:
a control system configured to receive a power supply and generate a pulse-width modulated output;
at least one heat-dissipating light-emitting diode (LED) array configured to receive the pulse-width modulated output and generate a pulsating light appearing to a human eye to include a steady-state light of at least a predetermined intensity, the heat-dissipating LED array including:
a plurality of LEDs configured to generate light in a selected spectrum; and
a heat-dissipating device configured to be disposed one of against or adjacent to the plurality of LEDs and dissipate heat generated by the LEDs;
a housing configured to contain the warning light, including:
a base configured to contain the control system and receive the power supply;
a lens configured to be disposed about the LED array and pass light in a spectrum equal to the selected spectrum in which the LEDs generate light; and
a light-conductive dome configured to contain the lens and the LED array;
a coupling configured to join the dome to the base,
wherein the warning light temperature output is within a specified temperature range.

17. The warning light of claim 16, wherein the predetermined intensity satisfies Class 1, Division 1 standards.

18. The warning light of claim 16, wherein the control system is configured to generate the pulse-width modulated output including:
an operating frequency of approximately 90 Hz to 100 Hz; and
an on-time of approximately 60 percent to 70 percent.

19. The warning light of claim 18, wherein the control system includes:
an LED driver circuit configured to apply power to the LED array when an on signal is applied to a shutdown (SHDN) input voltage; and
a solid-state timer configured to generate an output signal configured to cause the on signal to be applied to the shutdown input voltage of the LED driver.

20. The warning light of claim 16, wherein the lens is configured to one or more of:
collimate light generated by the LED array in at least one dimension; and
disperse light generated by the LED array in at least one dimension.

21. The warning light of claim 16, wherein the lens is integrated with the dome of the housing.

22. The warning light of claim 16, wherein the specified temperature range satisfies a T-code T6 standard.

23. The warning light of claim 16, wherein:
the heat-dissipating device is thermally coupled to the base of housing such that the heat-dissipating device is configured to absorb heat generated by the LEDs and transfer the heat to the base of housing; and
the base of the housing includes a heat-dissipating material.

24. The warning light of claim 23, wherein the heat sink includes a heat pipe coupled to the base of the housing by one or more aluminum brackets.

25. The warning light of claim 16, wherein the control system is configured to receive the power supply from one of:
one or more batteries accommodated within the base of the housing;
an external direct current (DC) power source; and
an external alternative current (AC) power source.

26. A method of generating a warning light signal, comprising:
providing at least one light-emitting diode (LED) array configured to generate light in a selected spectrum;
receiving the LED array in a lens color-matched to pass light in the selected spectrum.
providing a pulsating power signal to the LED array causing the LED array to generate a pulsating light appearing to a human eye to include a steady-state light of at least a predetermined intensity;
containing the LED array within a housing; and
limiting an operating temperature output radiated by the housing, including:
configuring the pulsating power signal to limit heat generated by the LED array; and
dispersing heat generated by the LED array through the housing.

27. The method of claim 26, wherein the predetermined intensity satisfies Class 1, Division 1 standards.

28. The method of claim 26, further comprising providing the pulsating power signal to the LED by providing a pulse-width modulated power signal including:
an operating frequency of approximately 90 Hz to 100 Hz; and
an on-time of approximately 60 percent to 70 percent.

29. The method of claim 28, wherein providing the pulse-width modulated power signal includes:
providing an LED driver circuit configured to apply power to the LED array when an on signal is applied to a shutdown (SHDN) input voltage; and
providing a solid-state timer configured to generate an output signal configured to cause the on signal to be applied to the shutdown input voltage of the LED driver.

30. The method of claim 16, wherein the operating temperature is limited to a range satisfying a T-code T6 standard.

31. The method of claim 26, wherein dispersing heat generated by the LED array through the housing includes:
providing a heat-dissipating device to transfer heat generated by the LED array to the housing; and
forming at least a portion of the housing from a heat-dissipating material.

32. The method of claim 31, wherein the heat-dissipating device includes a heat pipe.
